(19) United States
(12) Patent Application Publication
(10) Pub. No.: US 2016/0128027 A1
(43) Pub. Date: May 5, 2016

(54) ADJACENT CHANNEL CO-EXISTENCE FOR D2D

(71) Applicant: QUALCOMM Incorporated, San Diego, CA (US)

(72) Inventors: Kapil GULATI, Franklin Park, NJ (US); Saurabha Rangrao TAVILDAR, Jersey City, NJ (US); Peter GAAL, San Diego, CA (US)

(21) Appl. No.: 14/879,830

(22) Filed: Oct. 9, 2015

Related U.S. Application Data
(60) Provisional application No. 62/074,558, filed on Nov. 3, 2014.

(51) Int. Cl. H04W 72/04; H04L 5/00; H04W 52/04; H04W 76/02

(52) U.S. Cl. CPC H04W 72/042; H04W 76/023; H04L 5/0048; H04W 52/04; H04W 88/02

(57) ABSTRACT

A method, an apparatus, and a computer-readable medium for wireless communication are provided. The apparatus determines to communicate through D2D communication on a first radio-frequency channel. Additionally, the apparatus detects a transmission of a base station transmitting on downlink on a second radio-frequency channel. Additionally, the apparatus determines D2D transmission parameters based on the detected transmission of the base station. Further, the apparatus communicates through D2D using the determined D2D transmission parameters.

### CROSS-REFERENCE TO RELATED APPLICATION(S)

This application claims the benefit of U.S. Provisional Application Ser. No. 62/074,558, entitled “Adjacent Channel Co-existence for D2D” and filed on Filing Date: Nov. 3, 2014, which is expressly incorporated by reference herein in its entirety.

### BACKGROUND

1. Field

The present disclosure relates generally to communication systems, and more particularly, to determining device-to-device (D2D) transmission parameters based on a detected transmission of a base station.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is Long Term Evolution (LTE). LTE is a set of enhancements to the Universal Mobile Telecommunications System (UMTS) mobile standard promulgated by Third Generation Partnership Project (3GPP). LTE is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

D2D communication may operate on the UL of the wide area network (WAN) spectrum. However D2D transmissions by a user equipment (UE) are not necessarily power controlled with respect to a nearby base station. This can cause unwanted interference on the spectrum, or radio-frequency channel, that is adjacent the operating spectrum of the UE. Accordingly, there is currently a need for power control of D2D transmissions, as well as a need for increased separation between the operating radio-frequency channel and the adjacent radio-frequency channel, to reduce interference to the adjacent radio-frequency channel that may be caused by the D2D transmissions.

### SUMMARY

In an aspect of the disclosure, a method, a computer readable medium, and an apparatus are provided. The method may be performed by a UE. The UE determines to communicate through D2D communication on a first radio-frequency channel. The UE detects a transmission of a base station transmitting on downlink on a second radio-frequency channel. The UE determines D2D transmission parameters based on the detected transmission of the base station. The UE communicates through D2D using the determined D2D transmission parameters.

### BRIEF DESCRIPTION OF THE DRAWINGS

FIG. 1 is a diagram illustrating an example of a network architecture in accordance with the systems and methods described herein.

FIG. 2 is a diagram illustrating an example of an access network in accordance with the systems and methods described herein.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network in accordance with the systems and methods described herein.

FIG. 7 is a diagram of a device-to-device communications system in accordance with the systems and methods described herein.

FIGS. 8-11 are diagrams illustrating an example of a radio-frequency channel used by a UE, and two adjacent radio-frequency channels in accordance with the systems and methods described herein.

FIG. 12 is a flow chart of a method of wireless communication by a UE in accordance with the systems and methods described herein.

FIG. 13 is another flow chart of a method of wireless communication by a UE in accordance with the systems and methods described herein.

FIG. 14 is another flow chart of a method of wireless communication by a UE in accordance with the systems and methods described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

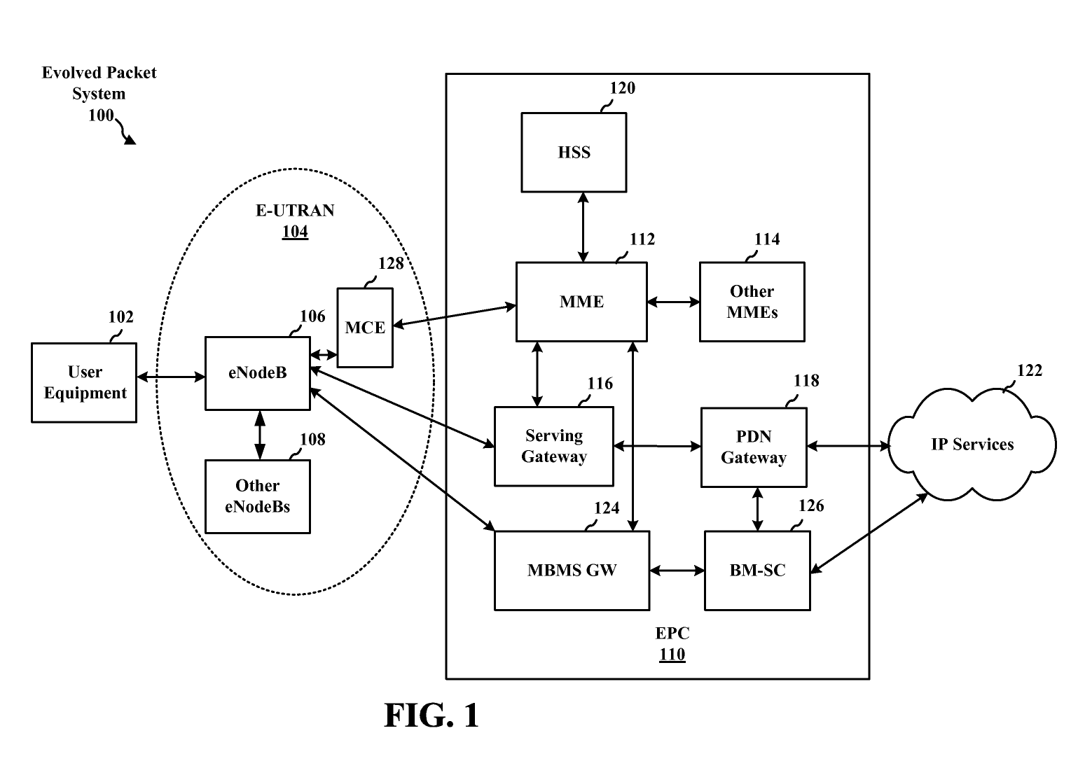

FIG. 1 is a diagram illustrating an LTE network architecture 100 in accordance with the systems and methods described herein. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, and an Operator's Internet Protocol (IP) Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108, and may include a Multicast Coordination Entity (MCE) 128. The eNB 106 provides user and control planes protocol terminations toward the UE 102. The eNB 106 may be connected to the other eNBs 108 via a backhaul (e.g., an X2 interface). The MCE 128 allocates time/frequency radio resources for evolved Multimedia Broadcast Multicast Service (MBMS) (eMBMS), and determines the radio configuration (e.g., a modulation and coding scheme (MCS)) for the eMBMS. The MCE 128 may be a separate entity or part of the eNB 106. The eNB 106 may also be referred to as a base station, a Node B, an access point, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. The UE 102 may implement one or more of the systems and methods described herein. For example, UE 102 may determine to communicate through D2D communication on a first radio-frequency channel. Additionally, the UE 102 may detect a transmission of a base station (e.g., eNB 106, 108) transmitting on downlink on a second radio-frequency channel. The UE 102 may determine D2D transmission parameters based on the detected transmission of the base station (e.g., eNB 106, 108). Additionally, the UE 102 may communicate through D2D using the determined D2D transmission parameters.

The eNB 106 is connected to the EPC 110. The EPC 110 may include a Mobility Management Entity (MME) 112, a Home Subscriber Server (HSS) 120, other MMEs 114, a Serving Gateway 116, a Multimedia Broadcast Multicast Service (MBMS) Gateway 124, a Broadcast Multicast Service Center (BM-SC) 126, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 and the BM-SC 126 are connected to the IP Services 122. The IP Services 122 may include the Internet, an intranet, an IP Multimedia Subsystem (IMS), a PS Streaming Service (PSS), and/or other IP services. The BM-SC 126 may provide functions for MBMS user service provisioning and delivery. The BM-SC 126 may serve as an entry point for content provider MBMS transmission, may be used to authorize and initiate MBMS Bearer Services within a public land mobile network (PLMN), and may be used to schedule and deliver MBMS transmissions. The MBMS Gateway 124 may be used to distribute MBMS traffic to the eNBs (e.g., 106, 108) belonging to a Multicast Broadcast Single Frequency Network (MBSFN) area broadcasting a particular service, and may be responsible for session management (start/stop) and for collecting eMBMS related charging information. The eNB 106, 108 may implement one or more of the systems and methods described herein.

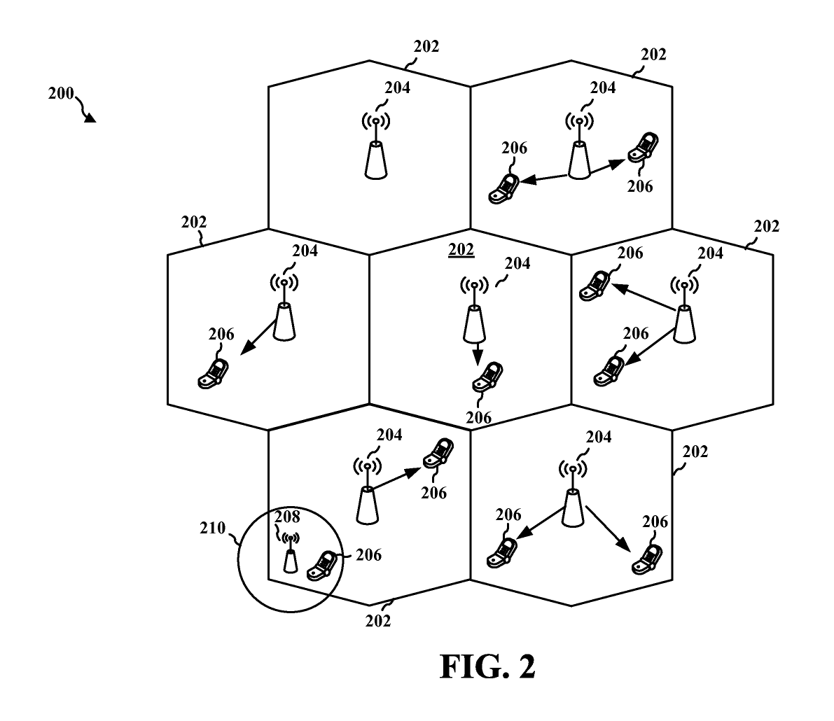

FIG. 2 is a diagram illustrating an example of an access network 200 in an LTE network architecture in accordance with the systems and methods described herein. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. An eNB may support one or multiple (e.g., three) cells (also referred to as a sectors). The term “cell” can refer to the smallest coverage area of an eNB and/or an eNB subsystem serving a particular coverage area. Further, the terms “eNB,” “base station,” and “cell” may be used interchangeably herein.

The modulation and multiple access scheme employed by the access network 200 may vary depending on the particular telecommunications standard being deployed. In LTE applications, OFDM is used on the DL and SC-FDMA is used on the UL to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream. The eNB 204, UEs 206, or both may implement one or more of the systems and methods described herein. For example, UE 206 may determine to communicate through D2D communication on a first radio-frequency channel. Additionally, the UE 206 may detect a transmission of a base station (e.g., eNB 204) transmitting on downlink on a second radio-frequency channel. The UE 206 may determine D2D transmission parameters based on the detected transmission of the base station (e.g., eNB 204). Additionally, the UE 206 may communicate through D2D using the determined D2D transmission parameters.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

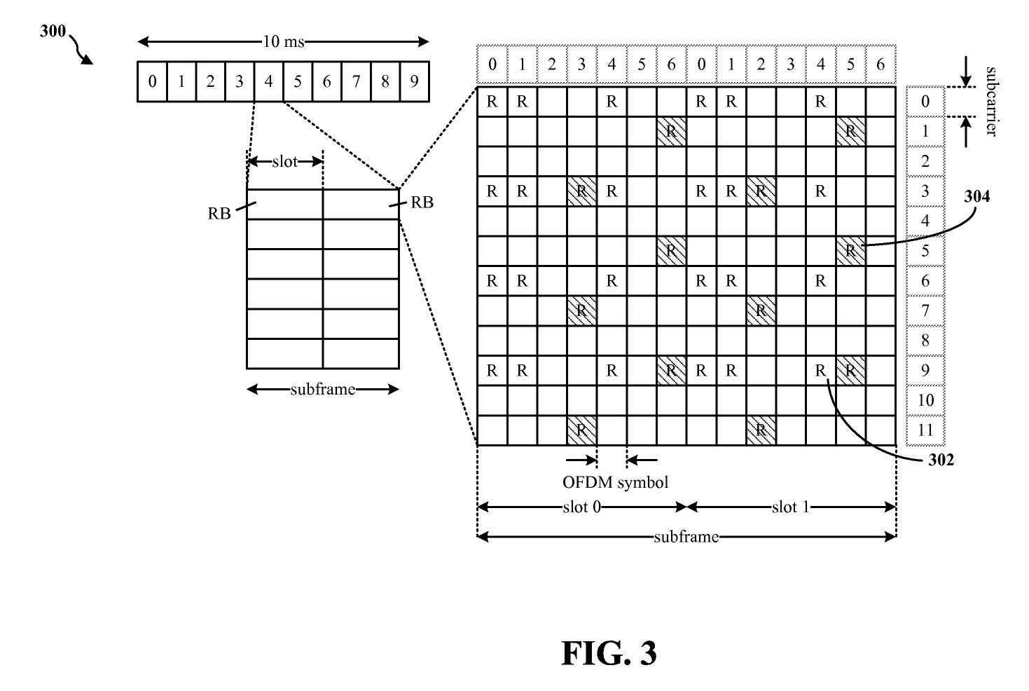

FIG. 3 is a diagram 300 illustrating an example of a DL frame structure in LTE. A frame (10 ms) may be divided into 10 equally sized subframes. Each subframe may include two consecutive time slots. A resource grid may be used to represent two time slots, each time slot including a resource block. The resource grid is divided into multiple resource elements. In LTE, for a normal cyclic prefix, a resource block contains 12 consecutive subcarriers in the frequency domain and 7 consecutive OFDM symbols in the time domain, for a total of 84 resource elements. For an extended cyclic prefix, a resource block contains 12 consecutive subcarriers in the frequency domain and 6 consecutive OFDM symbols in the time domain, for a total of 72 resource elements. Some of the resource elements, indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

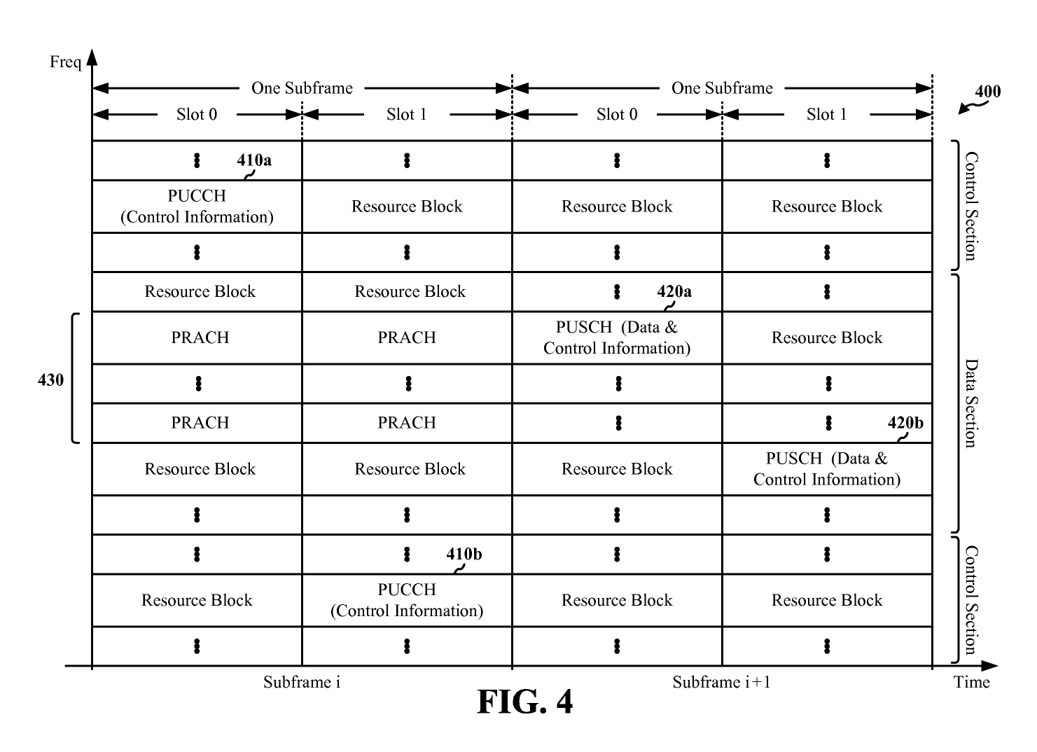

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make a single PRACH attempt per frame (10 ms).

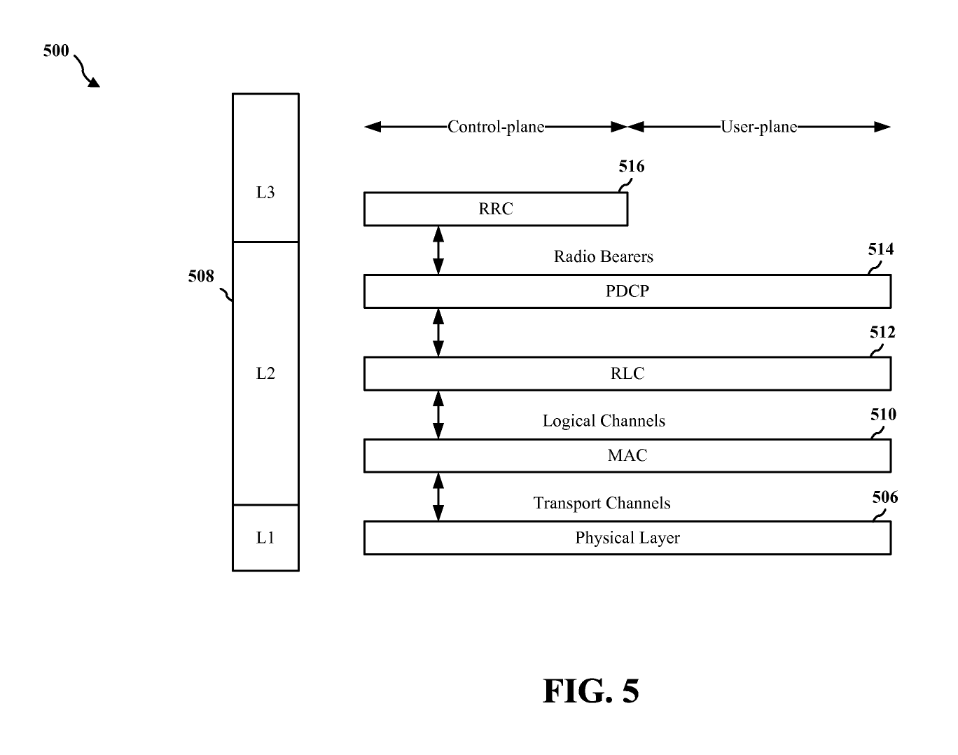

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARM). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (e.g., radio bearers) and for configuring the lower layers using RRC signaling between the eNB and the UE.

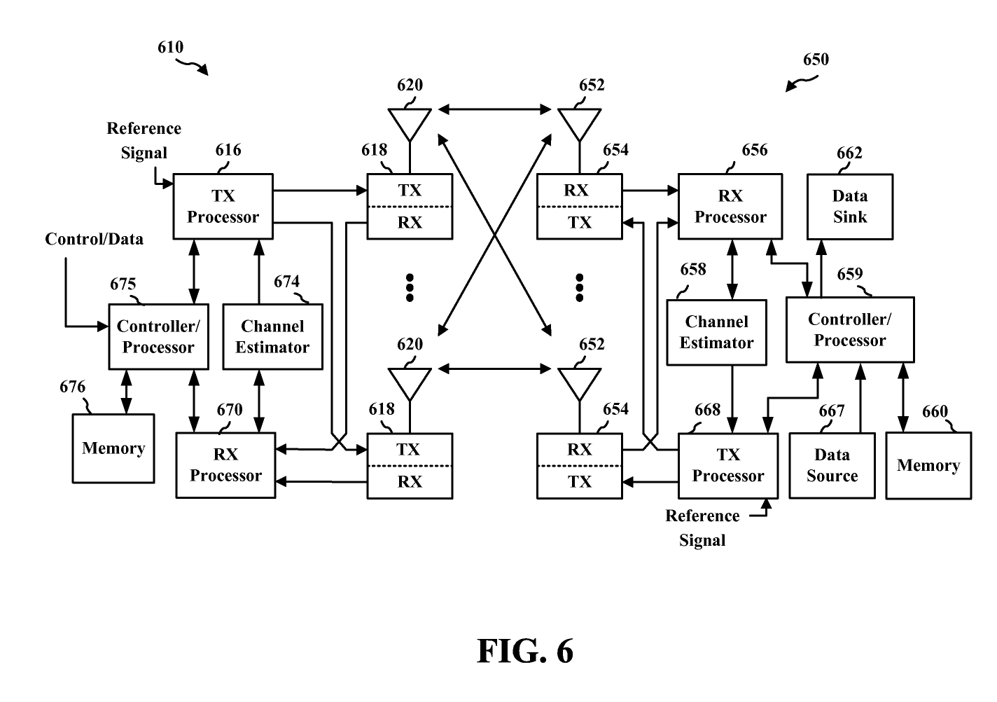

FIG. 6 is a block diagram of an eNB 610 in communication with a UE 650 in an access network in accordance with the systems and methods described herein. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions include coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream may then be provided to a different antenna 620 via a separate transmitter 618TX. Each transmitter 618TX may modulate an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 may perform spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor 659 can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 may be provided to different antenna 652 via separate transmitters 654TX. Each transmitter 654TX may modulate an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations. The eNB 610, UE 650, or both may implement one or more of the systems and methods described herein. For example, UE 650 may determine to communicate through D2D communication on a first radio-frequency channel. Additionally, the UE 650 may detect a transmission of a base station (e.g., eNB 610) transmitting on downlink on a second radio-frequency channel. The UE 650 may determine D2D transmission parameters based on the detected transmission of the base station (e.g., eNB 610). Additionally, the UE 650 may communicate through D2D using the determined D2D transmission parameters.

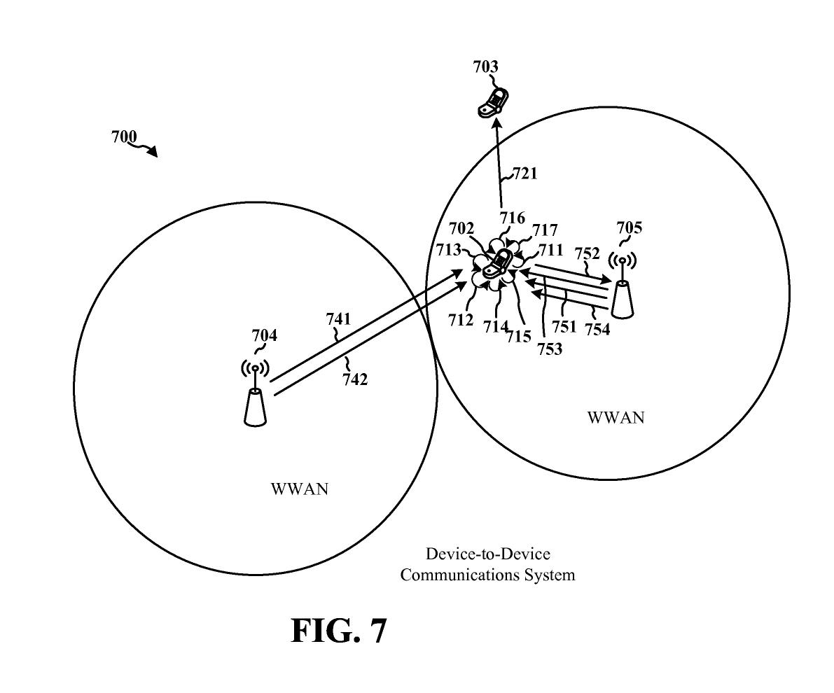

FIG. 7 is a diagram of a device-to-device communications system 700 in accordance with the systems and methods described herein. The device-to-device communications system 700 includes a plurality of wireless devices, e.g., UEs 702 and 703. The device-to-device communications system 700 may overlap with one or more cellular communications systems, such as for example, one or more wireless wide area networks (WWANs). The wireless devices, e.g., UEs 702 and 703 may communicate together in device-to-device communication using the DL/UL WWAN spectrum. The wireless device, e.g., UE 702 may also communicate with the serving base station, e.g., the eNB 705.

The exemplary methods and apparatuses discussed infra are applicable to any of a variety of wireless device-to-device communications systems, such as for example, a wireless device-to-device communication system based on FlashLinQ, WiMedia, Bluetooth, ZigBee, or Wi-Fi based on the IEEE 802.11 standard. To simplify the discussion, the exemplary methods and apparatus are discussed within the context of LTE. However, one of ordinary skill in the art would understand that the exemplary methods and apparatuses are applicable more generally to a variety of other wireless device-to-device communication systems.

As discussed supra, a D2D transmission 721 from a wireless device, e.g., UE 702 to a wireless device, e.g., neighboring UE 703 is not necessarily power controlled while considering the potential effect on a neighboring base station. Accordingly, the D2D transmissions 721 from the UE 702 on the operating spectrum may cause unwanted interference on an adjacent spectrum, or radio-frequency channel, which is used by a base station such as an eNB 704 (e.g., an adjacent spectrum used by a base station, e.g., the eNB 704 transmitting on DL).

The eNB 704, 705, UE 702, 703, or both may implement one or more of the systems and methods described herein. For example, UE 702, 703 may determine to communicate through D2D communication on a first radio-frequency channel. Additionally, the UE 702, 703 may detect a transmission of a base station (e.g., the eNB 704, 705) transmitting on downlink on a second radio-frequency channel. The UE 702, 703 may determine D2D transmission parameters based on the detected transmission of the base station (e.g., the eNB 704, 705). Additionally, the UE 702, 703 may communicate through D2D using the determined D2D transmission parameters.

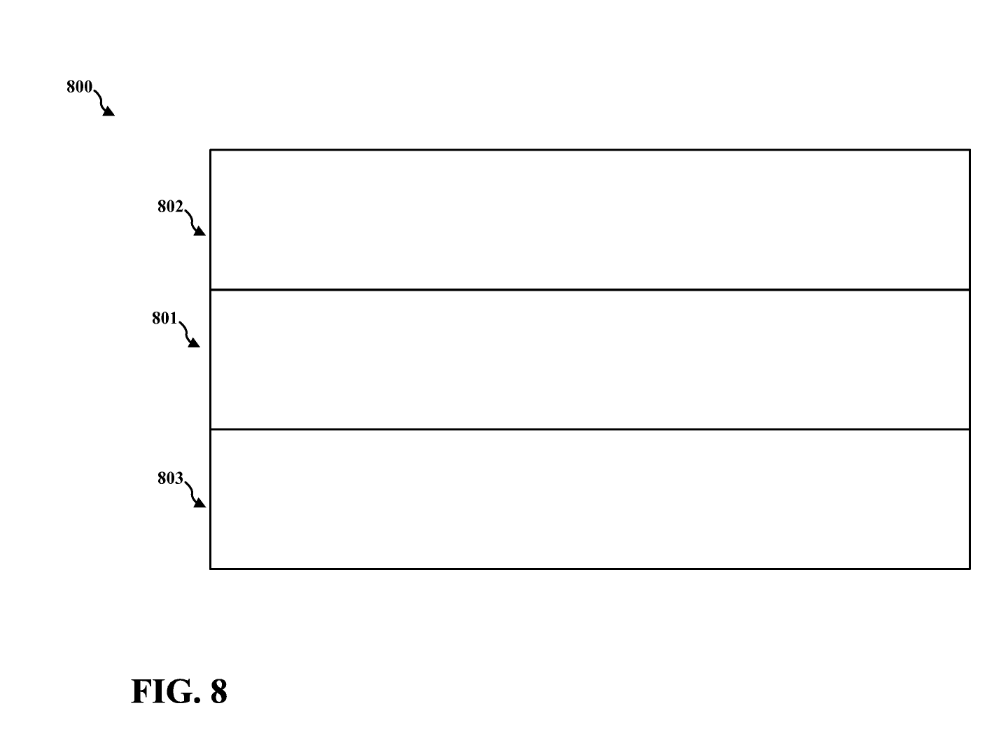

FIG. 8 is a diagram illustrating an example of a radio-frequency channel 801 used by a UE 702, and two adjacent radio-frequency channels 802, 803 in accordance with the systems and methods described herein. Referring to FIGS. 7 and 8, the UE 702 may communicate with the neighboring UE 703 through D2D communication 721 on a first radio-frequency channel 801 as the operating spectrum. Depending on the power used and/or the resources used by the UE 702 to send D2D transmission 721 to the neighboring UE 703, depending on the proximity of the UE 702 to the neighboring base station such as the eNB 704, and depending on whether one or more neighboring base stations (e.g., neighboring base station, the eNB 704) are using one or both of adjacent radio-frequency channels 802 and 803, the D2D transmission 721 by the UE 702 may interfere with communications occurring on the adjacent radio-frequency channels 802 and 803.

Accordingly, configurations described herein enable the UE 702 to detect the neighboring base station, the eNB 704 to determine 713 whether the UE 702 should use any particular D2D transmission parameters in the D2D communication 721 with the neighboring UE 703.

For example, the UE 702 may either receive 751 a command from a serving base station, e.g., the eNB 705, to search for the neighboring base station, the eNB 704, or may decide to attempt to detect the neighboring base station, the eNB 704 according to a set of instructions stored in the UE 702. The command from the serving base station, e.g., the eNB 705, may be simply a generalized command to search for a neighboring base station, the eNB 704, or may be a set of instructions that tell the UE 702 which specific frequencies to monitor in the UE's search for the neighboring base station, the eNB 704. Then, the UE 702 will search in adjacent radio-frequency channels, and will detect the neighboring base station, the eNB 704, if it is operating on one of the adjacent radio-frequency channels. The UE 702 may detect the neighboring base station, e.g., the 704, and may then receive a reference signal or may then seek to read one or more a system information blocks (SIBs) transmitted 741, 742 by the neighboring base station, e.g., the 704.

Thereafter, the UE 702 may analyze the reference signals or the SIB to either determine 714 a reference signal received power (RSRP) of the reference signals or to obtain 717 one or more power control parameters based on the SIB. Then, based on the UE's analysis, the UE 702 either may set or adjust 715 a transmission power to be used in its D2D communication 721 on the radio-frequency channel 801 with the neighboring UE 703 (e.g., a transmission power to be used to avoid causing interference on radio-frequency channels 802 or 803 while still allowing the neighboring UE 703 to receive the D2D communication 721), or may select 716 a set of resources having separation from the neighboring radio-frequency channels 802 or 803 (e.g., separation from resources at the bottom of radio-frequency channel 802 and/or separation from resources at the top of radio-frequency channel 803). For example, if the UE 702 determines that the RSRP of the neighboring base station, e.g., the eNB 704, is relatively high, which may be caused by the proximity of the UE 702 to the neighboring base station, e.g., the eNB 704, then the UE 702 can determine to use a relatively low transmit power in its D2D communication 721 with the neighboring UE 703.

Furthermore, in other configurations, the neighboring base station, the eNB 704, may be a “D2D aware” eNB. By being aware of the UE 702 that will engage in D2D communications with the neighboring UE 703, the neighboring base station, e.g., the eNB 704, may use one or more SIBs to instruct the UE 702 what power parameters to use in the D2D transmission 721 to the neighboring UE 703. That is, the neighboring base station, e.g., the 704, may broadcast power parameters to the UE 702 in one or more SIBs to effectively tell the UE 702 to transmit 721 at a particular power, to transmit 721 using a particular set of resources, or to transmit 721 according to a particular set of power control parameters. Additionally, in other configurations, the decision to have the UE 702 adjust the UE's transmit power may depend on a type of D2D transmission of the UE 702. For example, whether and to what degree the UE 702 adjusts its transmit power may be based on the physical channels of the D2D transmission, or based on whether the UE 702 is transmitting a discovery signal, a scheduling assignment (SA), or a data transmission.

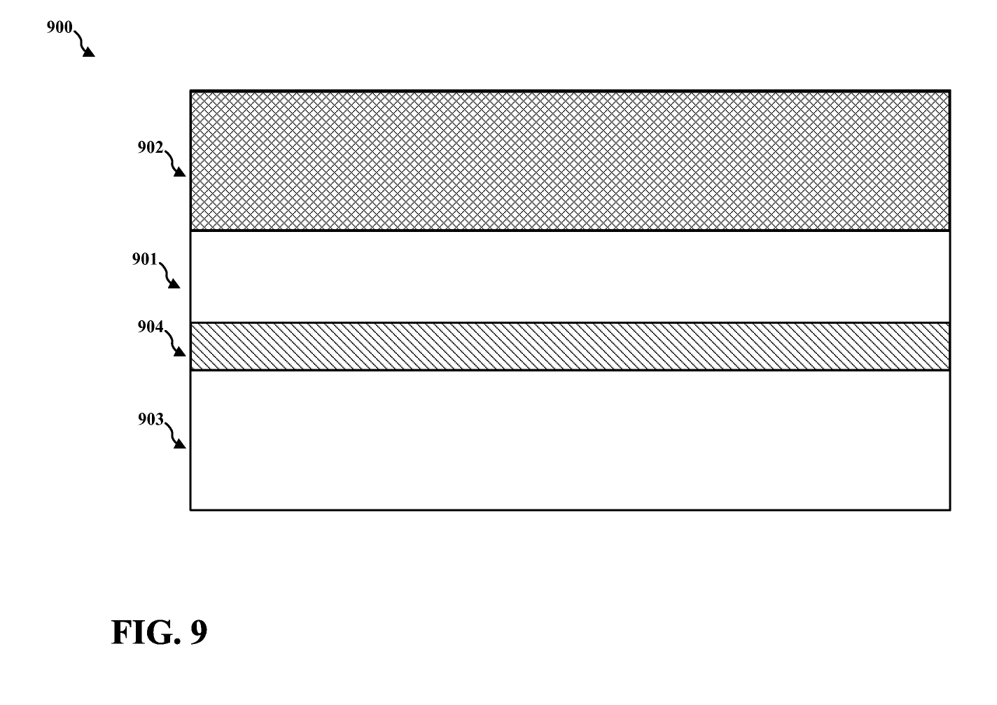

FIG. 9 is a diagram illustrating an example of a radio-frequency channel 901 used by a UE 702, and two adjacent radio-frequency channels 902, 903 in accordance with the systems and methods described herein. In FIG. 9, the UE 702 has detected 712 a transmission 741, 742 of the neighboring base station, the e.g., eNB 704, to determine that the neighboring base station, the eNB 704, is communicating on adjacent radio-frequency channel 902 (e.g., a second radio-frequency channel 902 that is adjacent the first radio-frequency channel 901). Furthermore, the UE 702 has not detected any communication of interest on adjacent radio-frequency channel 903. Accordingly, based on the UE's analysis in the present configuration, the UE selects 716 a set of resources 904 of the radio-frequency channel 901 for the D2D transmission 721 to achieve separation from the adjacent radio-frequency channel 902, such that the UE 702 engaging in the D2D communication 721 with the neighboring UE 703 using the selected set of resources 904 is less likely to cause interference on the adjacent radio-frequency channel 902 used by the neighboring base station, e.g., eNB 704. That is, in the present example, the UE 702 may have determined 714 that the RSRP of the neighboring base station, e.g., eNB 704, in the adjacent radio-frequency channel 902 is relatively high, and as a result, has decided to operate on a lower portion of the radio-frequency channel 901 (e.g., decided to operating using the lower 5 MHz of a 10 MHz channel). Because the lower portion of the radio-frequency channel 901 is further away from the adjacent bandwidth 902 used by the neighboring base station, e.g., the eNB 704, the chance that the UE 702 will interfere with the adjacent radio-frequency channel 902 is reduced, as the separation decreases the chance that the UE's D2D communications will “leak” into the adjacent radio-frequency channel 902.

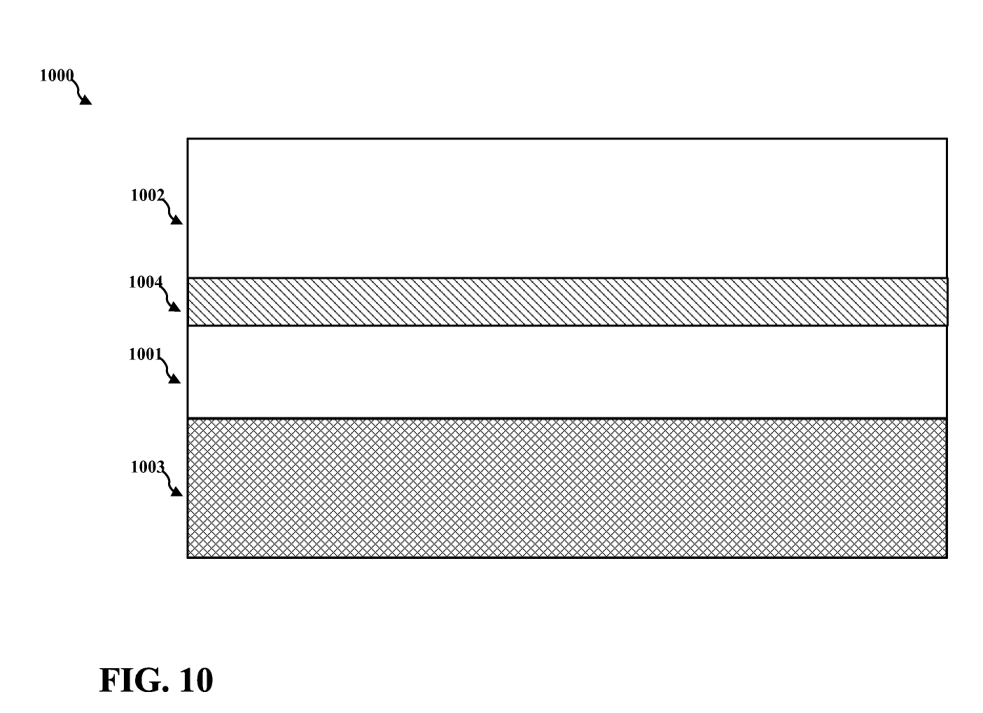

FIG. 10 is a diagram illustrating an example of a radio-frequency channel 1001 used by a UE 702, and two adjacent radio-frequency channels 1002, 1003 in accordance with the systems and methods described herein. FIG. 10 is similar to FIG. 9, in that the UE 702 is communicating on a first radio-frequency channel 1001, which is between two adjacent radio-frequency channels 1002, 1003 on the frequency spectrum. However, unlike FIG. 9, the UE 702 has detected the neighboring base station, the eNB 704, on a lower adjacent radio-frequency channel 1003 instead of the higher adjacent radio-frequency channel 1002 (and has not detected any communication of interest on adjacent radio-frequency channel 1002). Accordingly, the UE 702 has selected 716 a set of resources 1004 toward an upper band of the radio-frequency channel 1001 to achieve an amount of separation from the adjacent radio-frequency channel 1003 used by the neighboring base station, e.g., the eNB 704.

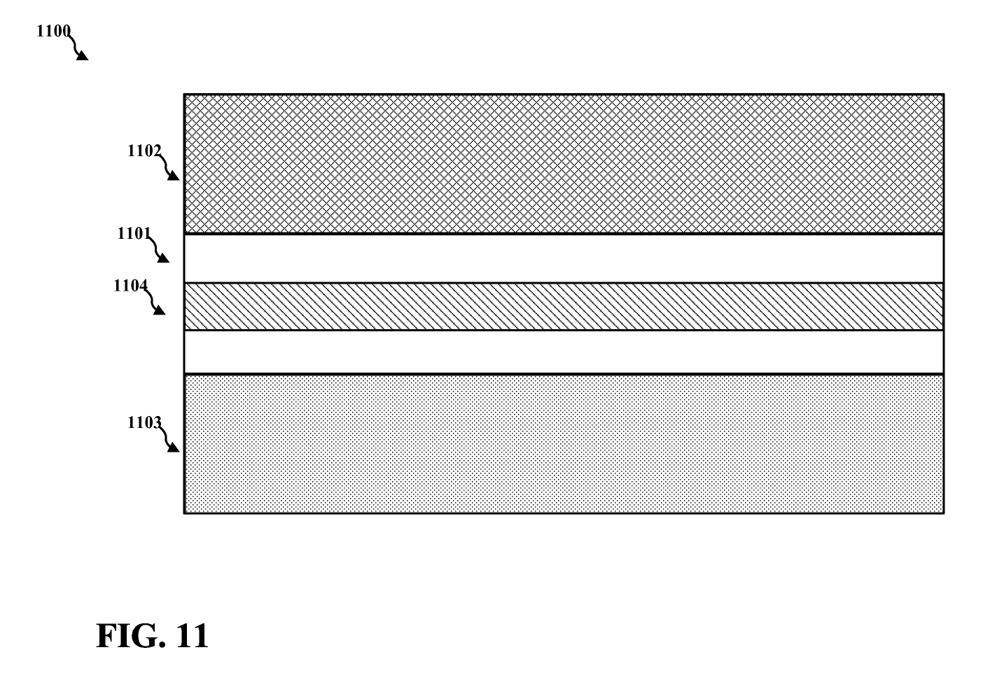

FIG. 11 is a diagram illustrating an example of a radio-frequency channel 1101 used by a UE 702, and two adjacent radio-frequency channels 1102, 1103 in accordance with the systems and methods described herein. FIG. 11 is similar to FIGS. 9 and 10, in that the UE 702 is communicating on a first radio-frequency channel 1101, which is between two adjacent radio-frequency channels 1102, 1103 on the frequency spectrum. However, unlike FIGS. 9 and 10, the UE 702 has detected one or more neighboring base stations (such as the neighboring base station, e.g., the eNB 704) on both of the adjacent radio-frequency channels 1102, 1103. Accordingly, in the present configuration, the UE 702 has selected 716 a set of resources 1104 toward a center of the band of the radio-frequency channel 1101 to achieve separation from both of the adjacent radio-frequency channels 1102, 1103.

Furthermore, although the above described configurations depict the UE 702 selecting 716 a set of resources 904, 1004, 1104 according to its detection of the neighboring base station, e.g., the eNB 704, on one or more of the adjacent radio-frequency channels 902, 1003, 1102, 1103, the UE may also adjust 715 the power of its D2D communication transmissions 721 to reduce or eliminate interference on neighboring radio-frequency channels. For example, the UE 702 may determine 714 an RSRP of the base station, e.g., the eNB 704, based on reference signals transmitted 741 and received from the base station, e.g., the eNB 704. Thereafter, the UE 702 may determine to adjust 715 a transmit power to be used for the D2D communication 721 based on the determined RSRP. Alternatively, the UE may transmit 752 information corresponding to the determined RSRP of the base station, e.g., the eNB 704 to the serving base station, e.g., the eNB 705, and may receive 754 instructions from the serving base station, e.g., the eNB 705, to adjust 715 the transmit power for the D2D communication 721 based on the determined RSRP. That is, by the UE 702 reporting back to the serving base station, e.g., the eNB 705, the base station, e.g., the eNB 705, can use the reported information corresponding to the RSRP to determine a path loss from the UE 702 to the neighboring base station, e.g., the eNB 704, and can then determine what adjustments or power control parameters to recommend to the UE 702.

Accordingly, once the UE 702 has adjusted the transmit power and/or selected the set of resources to be used in its D2D communication, the UE 702 may communicate 721 with the neighboring UE 703 using the adjusted transmit power and/or the selected set of resources without interfering with the radio-frequency channel(s) used by the neighboring base station, e.g., the eNB 704.

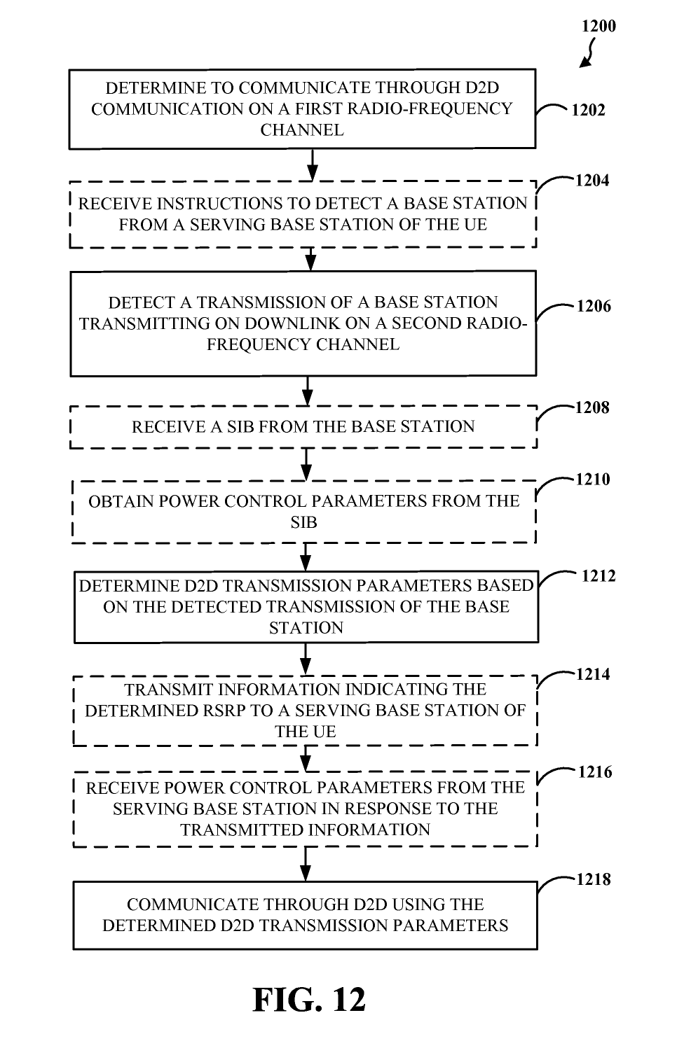

FIG. 12 is a flow chart 1200 of a method of wireless communication by a UE in accordance with the systems and methods described herein. The method may be performed by a UE, such as the UE 102 illustrated in FIG. 1, the UE 206 illustrated in FIG. 2, the UE 650 illustrated in FIG. 6, or the UE 702 illustrated in FIG. 7 At block 1202, a decision to communicate through D2D communication on a first radio-frequency channel is determined. For example, referring to FIGS. 7-11, the UE 702 may determine 711 to communicate through D2D communication (e.g., to transmit 721 a D2D communication to UE 703) on a first radio-frequency channel 801, 901, 1001, 1101. Referring to FIG. 6, RX processor 656, controller/processor 659, TX processor 668 may determine a decision to communicate through D2D communication on a first radio-frequency channel.

At block 1204, instructions to detect a base station may be received from a serving base station of the UE. For example, UE 102 illustrated in FIG. 1, the UE 206 illustrated in FIG. 2, the UE 650 illustrated in FIG. 6, or the UE 702 illustrated in FIG. 7 may receive 751 instructions to detect the base station, e.g., the eNB 704, from a serving base station, e.g., the eNB 705, of the UE 702. Referring to FIG. 6, RX processor 656 may receive instructions to detect a base station from a serving base station of the UE through antenna 652 and receiver 654RX.

At block 1206, a transmission of a base station transmitting on downlink on a second radio-frequency channel may be detected. The second radio-frequency channel may be an unpaired channel adjacent the first radio-frequency channel. Alternatively, the second radio-frequency channel may be paired with an uplink channel that is adjacent the first radio-frequency channel. The base station may be detected according to a preconfigured algorithm option of the UE, e.g., the UE 102 illustrated in FIG. 1, the UE 206 illustrated in FIG. 2, the UE 650 illustrated in FIG. 6, or the UE 702 illustrated in FIG. 7. Alternatively, the base station may be detected according to instructions received from the serving base station of the UE. For example, referring to FIGS. 7-11, and according to a preconfigured algorithm option of the UE 702 or according to instructions 751 received from the serving base station, e.g., the eNB 705, of the UE 702 (e.g., as described with respect to block 1204), the UE 702 may detect 712 a transmission 741 of a base station, e.g., the eNB 704, transmitting on downlink on a second radio-frequency channel 802, 902, 1003, 1102, 1103, which may be an unpaired channel adjacent the first radio-frequency channel 801, 901, 1001, 1101, or may be a channel that is paired with an uplink channel that is adjacent the first radio-frequency channel 801, 901, 1001, 1101. At block 1208, a SIB may be received from the base station. At block 1210, power control parameters may be obtained from the SIB. For example, referring to FIG. 7, the UE 702 may receive 742 a SIB from the base station, e.g., the eNB 704, and may obtain 717 power control parameters from the SIB.

At block 1212, D2D transmission parameters based on the detected transmission of the base station may be determined. Determining the D2D transmission parameters may include receiving reference signals from the base station, determining an RSRP of the received reference signals, and adjusting a transmit power for the D2D communication based on the determined RSRP. The transmit power may be adjusted further based on preconfigured power control parameters of the UE. The transmit power may be adjusted further based on physical channels of the D2D communication. Determining the D2D transmission parameters may include selecting a set of resources within the first radio-frequency channel for the D2D communication based on the detected transmission of the base station on the second radio-frequency channel. Determining the D2D transmission parameters may further include receiving reference signals from the base station on the second radio-frequency channel, and determining an RSRP of the received reference signals, with the set of resources being further selected based on the determined RSRP. The set of resources may be further selected based on a physical channel of the D2D communication. Determining the D2D transmission parameters may include receiving reference signals from the base station on the second radio-frequency channel, determining an RSRP of the received reference signals, transmitting information indicating the determined RSRP to a serving base station of the UE, and receiving a set of resources within the first radio-frequency channel for D2D communication from the serving base station in response to the transmitted information. For example, referring to FIGS. 7-11 the UE 702 may determine 713 D2D transmission parameters based on the detected transmission 741 of the base station, e.g., the eNB 704. The D2D transmission parameters may be determined 713 by receiving reference signals transmitted 741 from the base station, e.g., the eNB 704, determining 714 an RSRP of the received reference signals transmitted 741, and adjusting 715 a transmit power for the D2D communication 721 based on the determined 714 RSRP (e.g., the transmit power may be adjusted 715 further based on preconfigured power control parameters of the UE 702, based on the power control parameters obtained 717 from the SIB, and/or based on physical channels of the D2D communication 721). The D2D transmission parameters may be determined 713 by selecting 716 a set of resources within the first radio-frequency channel 801, 901, 1001, 1101 for the D2D communication 721 based on the detected transmission 741 of the base station, e.g., the eNB 704, on the second radio-frequency channel 802, 902, 1003, 1102, 1103 (e.g., the set of resources may be further selected 716 based on the determined 714 RSRP and/or based on a physical channel of the D2D communication 721). The D2D transmission parameters may be determined 713 by receiving reference signals transmitted 741 from the base station, e.g., the eNB 704, on the second radio-frequency channel 802, 902, 1003, 1102, 1103, determining 714 an RSRP of the received reference signals transmitted 741, transmitting 752 information indicating the determined 714 RSRP to a serving base station, e.g., the eNB 705, of the UE 702, and receiving 753 a set of resources within the first radio-frequency channel 801, 901, 1001, 1101 for D2D communication 721 from the serving base station, e.g., the eNB 705, in response to the transmitted 752 information.

At block 1214, information indicating the determined RSRP may be transmitted to a serving base station of the UE, e.g., UE 102 illustrated in FIG. 1, the UE 206 illustrated in FIG. 2, the UE 650 illustrated in FIG. 6, or the UE 702 illustrated in FIG. 7. At block 1216, power control parameters may be received from the serving base station in response to the transmitted information. The transmit power may be adjusted further based on the received power control parameters. For example, referring to FIG. 7, the UE 702 may transmit 752 information indicating the determined 714 RSRP to a serving base station, e.g., the eNB 705, of the UE 702, and may receive 754 power control parameters from the serving base station, e.g., the eNB 705, in response to the transmitted information 752.

At block 1218, a communication through D2D using the determined D2D transmission parameters may occur. For example, referring to FIG. 7, the UE 702 may communicate 721 (e.g., with the UE 703) through D2D using the determined 713 D2D transmission parameters.

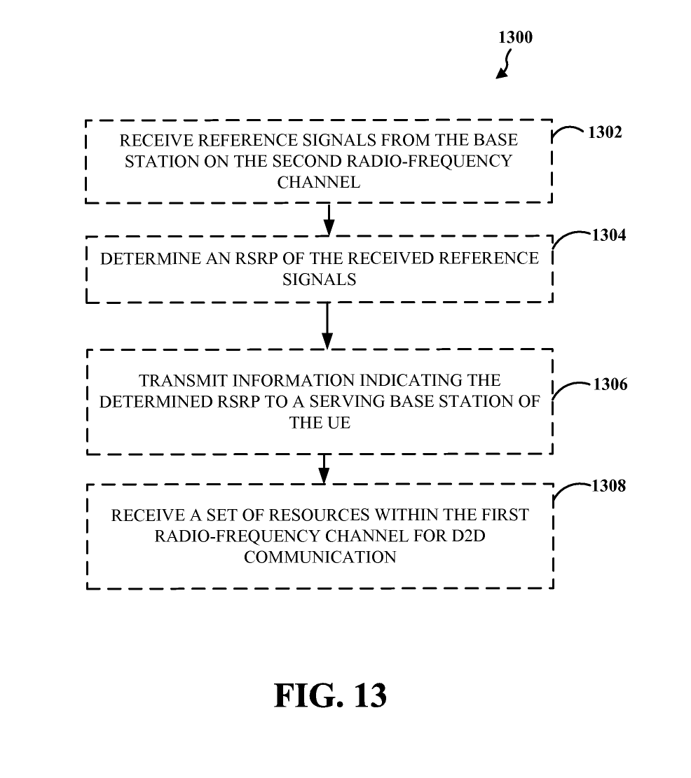

FIG. 13 is another flow chart 1300 of a method of wireless communication by a UE in accordance with the systems and methods described herein. The method may be performed by a UE, such as the UE 102 illustrated in FIG. 1, the UE 206 illustrated in FIG. 2, the UE 650 illustrated in FIG. 6, or the UE 702 illustrated in FIG. 7. As illustrated in FIG. 13, determining the D2D transmission parameters may include, one or more of blocks 1302, 1304, 1306, or 1308.

At block 1302, receive reference signals from the base station on the second radio-frequency channel. For example, the UE 102 illustrated in FIG. 1, the UE 206 illustrated in FIG. 2, the UE 650 illustrated in FIG. 6, or the UE 702 illustrated in FIG. 7 may receive reference signals from a base station on the second radio-frequency channel. The base station may be eNB 106 of FIG. 1, other eNB 108, eNB 204, 208, of FIG. 2, eNB 610 of FIG. 6, eNB 704, 705 of FIG. 7. Referring to FIG. 6, RX processor 656 may receive reference signals from the base station on the second radio-frequency channel through antenna 652 and receiver 654RX.

At block 1304, determine a RSRP of the received reference signals. For example, the UE 102 illustrated in FIG. 1, the UE 206 illustrated in FIG. 2, the UE 650 illustrated in FIG. 6, or the UE 702 may determine a RSRP of the received reference signals. Referring to FIG. 6, RX processor 656, controller/processor 659, TX processor 668 may determine a RSRP of the received reference signals.

At block 1306, transmit information indicating the determined RSRP to a serving base station of the UE. For example, the UE 102 illustrated in FIG. 1, the UE 206 illustrated in FIG. 2, the UE 650 illustrated in FIG. 6, or the UE 702 may transmit information indicating the determined RSRP to a serving base station of the UE. The base station may be eNB 106 of FIG. 1, other eNB 108, eNB 204, 208, of FIG. 2, eNB 610 of FIG. 6, eNB 704, 705 of FIG. 7. Referring to FIG. 6, TX processor 668, transmitter 654, and antenna 652 may transmit information indicating the determined RSRP to a serving base station of the UE.

At block 1308, receive a set of resources within the first radio-frequency channel for D2D communication from the serving base station in response to the transmitted information. For example, the UE 102 illustrated in FIG. 1, the UE 206 illustrated in FIG. 2, the UE 650 illustrated in FIG. 6, or the UE 702 may receive a set of resources within the first radio-frequency channel for D2D communication from the serving base station in response to the transmitted information. Referring to FIG. 6, RX processor 656 may receive a set of resources within the first radio-frequency channel for D2D communication from the serving base station in response to the transmitted information from antenna 652, receiver 654RX.

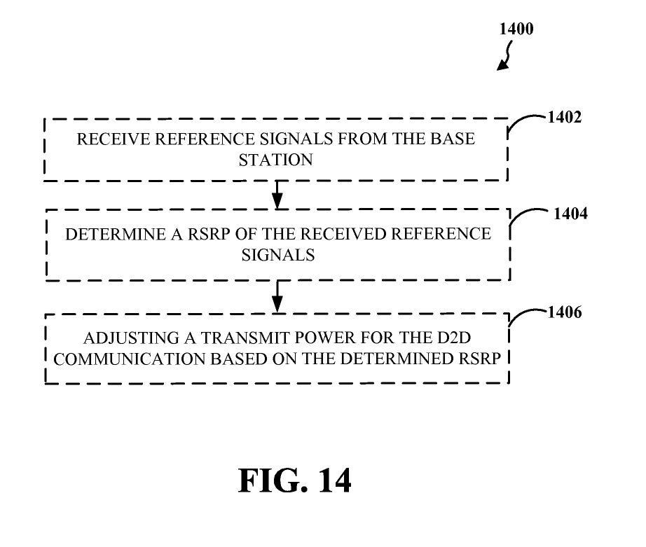

FIG. 14 is another flow chart of a method of wireless communication by a UE in accordance with the systems and methods described herein. The method may be performed by a UE, such as the UE 102 illustrated in FIG. 1, the UE 206 illustrated in FIG. 2, the UE 650 illustrated in FIG. 6, or the UE 702 illustrated in FIG. 7. As illustrated in FIG. 14, determining the D2D transmission parameters may include, one or more of blocks 1402, 1404, or 1406.

At block 1402, receive reference signals from the base station. For example, the UE 102 illustrated in FIG. 1, the UE 206 illustrated in FIG. 2, the UE 650 illustrated in FIG. 6, or the UE 702 illustrated in FIG. 7 may receive reference signals from the base station. The base station may be eNB 106 of FIG. 1, other eNB 108, eNB 204, 208, of FIG. 2, eNB 610 of FIG. 6, eNB 704, 705 of FIG. 7. Referring to FIG. 6, RX processor 656 may receive reference signals from the base station through antenna 652 and receiver 654RX.

At block 1404, determine a RSRP of the received reference signals. For example, the UE 102 illustrated in FIG. 1, the UE 206 illustrated in FIG. 2, the UE 650 illustrated in FIG. 6, or the UE 702 illustrated in FIG. 7 may determine a RSRP of the received reference signals. Referring to FIG. 6, RX processor 656, controller/processor 659, TX processor 668 may determine a RSRP of the received reference signals.

At block 1406, adjust a transmit power for the D2D communication based on the determined RSRP. For example, the UE 102 illustrated in FIG. 1, the UE 206 illustrated in FIG. 2, the UE 650 illustrated in FIG. 6, or the UE 702 illustrated in FIG. 7 may adjust a transmit power for the D2D communication based on the determined RSRP. Referring to FIG. 6, RX processor 656, controller/processor 659, TX processor 668 may adjust a transmit power for the D2D communication based on the determined RSRP.

In one configuration, the apparatus for wireless communication includes means for determining to communicate through D2D communication on a first radio-frequency channel. In addition, the apparatus include means for detecting a transmission of a base station transmitting on downlink on a second radio-frequency channel. In addition, the apparatus include means for determining D2D transmission parameters based on a detected transmission of the base station. Further, the apparatus include means for communicating through D2D using determined D2D transmission parameters.

In one configuration, the means for determining the D2D transmission parameters is configured to (1) receive reference signals from the base station, (2) determine a RSRP of the received reference signals, and (3) adjust a transmit power for the D2D communication based on the determined RSRP.

In one configuration, the apparatus further includes means for receiving a SIB from the base station. In addition, the apparatus include means for obtaining power control parameters from the SIB. Furthermore, the means for determining the D2D transmission parameters may be configured to adjust the transmit power further based on the obtained power control parameters.

In one configuration, the means for determining the D2D transmission parameters is configured to adjust the transmit power further based on preconfigured power control parameters of the UE.

In one configuration, the means for determining the D2D transmission parameters is configured to adjust the transmit power is further based on physical channels of the D2D communication.

In one configuration, the apparatus further includes means for transmitting information indicating a determined RSRP to a serving base station of the UE.

In one configuration, the apparatus further includes means for receiving power control parameters from the serving base station in response to transmitted information indicating the determined RSRP to a serving base station of the UE. The means for determining the D2D transmission parameters may be configured to adjust the transmit power further based on the received power control parameters.

In one configuration, the apparatus further includes means for receiving instructions to detect the base station from a serving base station of the UE.

In one configuration, the means for detecting a transmission of a base station may be configured to detect the base station according to a preconfigured algorithm option of the UE.

In one configuration, the means for determining the D2D transmission parameters is configured to select a set of resources within the first radio-frequency channel for the D2D communication may be based on a detected transmission of the base station on the second radio-frequency channel.

In one configuration, the means for determining the D2D transmission parameters is configured to select the set of resources based on a physical channel of the D2D communication.

In one configuration, the means for determining the D2D transmission parameters is configured to (1) receive reference signals from the base station on the second radio-frequency channel, (2) determine a RSRP of the received reference signals, and (3) select the set of resources based on the determined RSRP.

In one configuration, the apparatus further includes means for transmitting information indicating a determined RSRP to a serving base station of the UE.

In one configuration, the means for determining the D2D transmission parameters is configured to (1) receive reference signals from the base station on the second radio-frequency channel, (2) determine a reference signal received power (RSRP) of received reference signals, (3) transmit information indicating a determined RSRP to a serving base station of the UE, and (4) receive a set of resources within the first radio-frequency channel for D2D communication from the serving base station in response to transmitted information.

In some examples, a means for determining to communicate through D2D communication on a first radio-frequency channel may include UE 102, UE 206, or UE 650. In the UE 650, for example, the means for determining to communicate through D2D communication on a first radio-frequency channel may include RX processor 656, TX processor 668, Controller/Processor 659, or some other processor or logic circuitry.

In some examples, a means for detecting a transmission of a base station transmitting on downlink on a second radio-frequency channel may include UE 102, UE 206, or UE 650. In the UE 650, for example, the means for detecting a transmission of a base station transmitting on downlink on a second radio-frequency channel may include antenna 652, receiver 654RX, RX processor 656, Controller/Processor 659, or some other processor or logic circuitry.

In some examples, a means for determining D2D transmission parameters based on a detected transmission of the base station may include UE 102, UE 206, or UE 650. In the UE 650, for example, the means for determining D2D transmission parameters based on a detected transmission of the base station may include RX processor 656, TX processor 668, Controller/Processor 659, or some other processor or logic circuitry.

In some examples, a means for communicating through D2D using determined D2D transmission parameters may include UE 102, UE 206, or UE 650. In the UE 650, for example, the means for communicating through D2D using determined D2D transmission parameters may include RX processor 656, TX processor 668, Controller/Processor 659, antenna 652, receiver 654RX, or transmitter 654TX.

In some examples, a means for receiving a system information block (SIB) from the base station may include UE 102, UE 206, or UE 650. In the UE 650, for example, the means for receiving a system information block (SIB) from the base station may include RX processor 656, Controller/Processor 659, antenna 652, or receiver 654RX.

In some examples, a means for obtaining power control parameters from the SIB may include UE 102, UE 206, or UE 650. In the UE 650, for example, the means for obtaining power control parameters from the SIB may include RX processor 656, Controller/Processor 659, antenna 652, or receiver 654RX.

In some examples, a means for transmitting information indicating a determined RSRP to a serving base station of the UE may include UE 102, UE 206, or UE 650. In the UE 650, for example, the means for transmitting information indicating a determined RSRP to a serving base station of the UE may include TX processor 668, Controller/Processor 659, antenna 652, or transmitter 654TX.

In some examples, a means for receiving power control parameters from the serving base station in response to transmitted information indicating the determined RSRP to a serving base station of the UE may include UE 102, UE 206, or UE 650. In the UE 650, for example, the means for receiving power control parameters from the serving base station in response to transmitted information indicating the determined RSRP to a serving base station of the UE may include RX processor 656, Controller/Processor 659, antenna 652, or receiver 654RX.

In some examples, a means for receiving instructions to detect the base station from a serving base station of the UE may include UE 102, UE 206, or UE 650. In the UE 650, for example, the means for receiving instructions to detect the base station from a serving base station of the UE may include may include RX processor 656, TX processor 668, Controller/Processor 659, antenna 652, transmitter 654TX.

In some examples, a means for transmitting information indicating a determined RSRP to a serving base station of the UE may include UE 102, UE 206, or UE 650. In the UE 650, for example, the a means for transmitting information indicating a determined RSRP to a serving base station of the UE may include TX processor 668, Controller/Processor 659, antenna 652, transmitter 654TX.

As described supra, a UE determines to communicate through D2D communication with another UE on a first radio-frequency channel. Then, either according to instructions received by the UE from a serving base station or according to instructions stored on the UE, the UE detects a neighboring base station transmitting on downlink on a second radio-frequency channel. Based on an analysis of a transmission of the neighboring base station, the analysis including, for example, determining an RSRP of the neighboring base station or by reading SIBs of the neighboring base station, the UE or the base station serving the UE determines D2D transmission parameters, such as a transmit power, or a set of resources, for the UE to use in the D2D communication, such that interference with the neighboring base station's communications caused by the D2D communication is reduced or eliminated. Then, the UE communicates with the other UE through D2D communication in accordance with the determined D2D transmission parameters.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication of a user equipment (UE), comprising:
determining to communicate through device to device (D2D) communication on a first radio-frequency channel;
detecting a transmission of a base station transmitting on downlink on a second radio-frequency channel;
determining D2D transmission parameters based on the detected transmission of the base station; and
communicating through D2D using the determined D2D transmission parameters.

2. The method of claim 1, wherein the second radio-frequency channel comprises an unpaired channel adjacent the first radio-frequency channel.

3. The method of claim 1, wherein the second radio-frequency channel is paired with an uplink channel that is adjacent the first radio-frequency channel.

4. The method of claim 1, wherein determining the D2D transmission parameters comprises:
receiving reference signals from the base station;
determining a reference signal received power (RSRP) of the received reference signals; and
adjusting a transmit power for the D2D communication based on the determined RSRP.

5. The method of claim 4, further comprising:
receiving a system information block (SIB) from the base station; and
obtaining power control parameters from the SIB,
wherein the transmit power is adjusted further based on the obtained power control parameters.

6. The method of claim 4, wherein the transmit power is adjusted further based on preconfigured power control parameters of the UE.

7. The method of claim 4, wherein the transmit power is adjusted further based on physical channels of the D2D communication.

8. The method of claim 4, further comprising transmitting information indicating the determined RSRP to a serving base station of the UE.

9. The method of claim 8, further comprising receiving power control parameters from the serving base station in response to the transmitted information,
wherein the transmit power is adjusted further based on the received power control parameters.

10. The method of claim 1, further comprising receiving instructions to detect the base station from a serving base station of the UE.

11. The method of claim 1, wherein the base station is detected according to a preconfigured algorithm option of the UE.

12. The method of claim 1, wherein determining the D2D transmission parameters comprises selecting a set of resources within the first radio-frequency channel for the D2D communication based on the detected transmission of the base station on the second radio-frequency channel.

13. The method of claim 12, wherein the set of resources is further selected based on a physical channel of the D2D communication.

14. The method of claim 12, wherein determining the D2D transmission parameters further comprises:
receiving reference signals from the base station on the second radio-frequency channel; and
determining a reference signal received power (RSRP) of the received reference signals,
wherein the set of resources is further selected based on the determined RSRP.

15. The method of claim 14, further comprising transmitting information indicating the determined RSRP to a serving base station of the UE.

16. The method of claim 1, wherein determining the D2D transmission parameters comprises:
receiving reference signals from the base station on the second radio-frequency channel;
determining a reference signal received power (RSRP) of the received reference signals;
transmitting information indicating the determined RSRP to a serving base station of the UE; and
receiving a set of resources within the first radio-frequency channel for D2D communication from the serving base station in response to the transmitted information.

17. An apparatus for wireless communication, comprising:
means for determining to communicate through device to device (D2D) communication on a first radio-frequency channel;
means for detecting a transmission of a base station transmitting on downlink on a second radio-frequency channel;
means for determining D2D transmission parameters based on a detected transmission of the base station; and
means for communicating through D2D using determined D2D transmission parameters.

18. The apparatus of claim 17, wherein the second radio-frequency channel comprises an unpaired channel adjacent the first radio-frequency channel.

19. The apparatus of claim 17, wherein the second radio-frequency channel is paired with an uplink channel that is adjacent the first radio-frequency channel.

20. The apparatus of claim 17, wherein the means for determining the D2D transmission parameters is configured to:
receive reference signals from the base station;
determine a reference signal received power (RSRP) of the received reference signals; and
adjust a transmit power for the D2D communication based on the determined RSRP.

21. The apparatus of claim 20, further comprising:
means for receiving a system information block (SIB) from the base station; and
means for obtaining power control parameters from the SIB,
wherein the means for determining the D2D transmission parameters is configured to adjust the transmit power further based on the obtained power control parameters.

22. The apparatus of claim 20, wherein the means for determining the D2D transmission parameters is configured to adjust the transmit power further based on preconfigured power control parameters of the UE.

23. The apparatus of claim 20, wherein the means for determining the D2D transmission parameters is configured to adjust the transmit power further based on physical channels of the D2D communication.

24. The apparatus of claim 20, further comprising means for transmitting information indicating a determined RSRP to a serving base station of the UE.

25. The apparatus of claim 24, further comprising means for receiving power control parameters from the serving base station in response to transmitted information indicating the determined RSRP to a serving base station of the UE,
wherein the means for determining the D2D transmission parameters is configured to adjust the transmit power further based on the received power control parameters.

26. The apparatus of claim 17, further comprising means for receiving instructions to detect the base station from a serving base station of the UE.

27. The apparatus of claim 17, wherein the means for detecting a transmission of a base station is configured to detect the base station according to a preconfigured algorithm option of the UE.

28. The apparatus of claim 17, wherein the means for determining the D2D transmission parameters is configured to select a set of resources within the first radio-frequency channel for the D2D communication based on a detected transmission of the base station on the second radio-frequency channel.

29. The apparatus of claim 28, wherein the means for determining the D2D transmission parameters is configured to select the set of resources based on a physical channel of the D2D communication.

30. The apparatus of claim 28, wherein the means for determining the D2D transmission parameters are further configured to:
receive reference signals from the base station on the second radio-frequency channel;
determine a reference signal received power (RSRP) of the received reference signals; and
select the set of resources based on the determined RSRP.

31. The apparatus of claim 30, further comprising means for transmitting information indicating a determined RSRP to a serving base station of the UE.

32. The apparatus of claim 17, wherein the means for determining the D2D transmission parameters is configured to:
receive reference signals from the base station on the second radio-frequency channel;
determine a reference signal received power (RSRP) of received reference signals;
transmit information indicating a determined RSRP to a serving base station of the UE; and
receive a set of resources within the first radio-frequency channel for D2D communication from the serving base station in response to transmitted information.

33. An apparatus for wireless communication, comprising:
a memory; and
at least one processor coupled to the memory and configured to:
determine to communicate through device to device (D2D) communication on a first radio-frequency channel;
detect a transmission of a base station transmitting on downlink on a second radio-frequency channel;
determine D2D transmission parameters based on the detected transmission of the base station; and
communicate through D2D using the determined D2D transmission parameters.

34. The apparatus of claim 33, wherein the second radio-frequency channel comprises an unpaired channel adjacent the first radio-frequency channel.

35. The apparatus of claim 33, wherein the second radio-frequency channel is paired with an uplink channel that is adjacent the first radio-frequency channel.

36. The apparatus of claim 33, wherein to determine the D2D transmission parameters, the at least one processor is configured to:
receive reference signals from the base station;
determine a reference signal received power (RSRP) of the received reference signals; and
adjust a transmit power for the D2D communication based on the determined RSRP.

37. The apparatus of claim 36, wherein the at least one processor is further configured to:
receive a system information block (SIB) from the base station; and
obtain power control parameters from the SIB,
wherein to determine the D2D transmission parameters, the at least one processor is configured to adjust the transmit power further based on the obtained power control parameters.

38. The apparatus of claim 36, wherein to determine the D2D transmission parameters, the at least one processor is configured to adjust the transmit power further based on preconfigured power control parameters of the UE.

39. The apparatus of claim 36, wherein to determine the D2D transmission parameters, the at least one processor is configured to adjust the transmit power further based on physical channels of the D2D communication.

40. A computer-readable medium storing computer executable code for wireless communication, comprising code to:
determine to communicate through device to device (D2D) communication on a first radio-frequency channel;
detect a transmission of a base station transmitting on downlink on a second radio-frequency channel;
determine D2D transmission parameters based on the detected transmission of the base station; and
communicate through D2D using the determined D2D transmission parameters.
